(19) United States
(12) Patent Application Publication
(10) Pub. No.: US 2008/0219324 A1
(43) Pub. Date: Sep. 11, 2008

(54) METHOD AND APPARATUS FOR GENERATING A HOPPING SEQUENCE IN A COMMUNICATION SYSTEM

(75) Inventors: Sung-Eun PARK, Seoul (KR); Tae-Young KIM, Seongnam-si (KR); Dong-Seek PARK, Yongin-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/045,299

(22) Filed: Mar. 10, 2008

(30) Foreign Application Priority Data
Mar. 9, 2007 (KR) 2007-0023524

(51) Int. Cl. H04B 1/713

(52) U.S. Cl. 375/132; 375/E01.035

(57) ABSTRACT

A method and apparatus for generating a hopping sequence according to a seed value in a communication system are provided. The apparatus and method for generating a hopping sequence indicating a hopping pattern of carrier frequencies or time slots in a communication system include, when a seed value is input, setting a window to be applied to the seed value, calculating a window value according to the set window and generating a sequence by storing values in sequence arrangement to the calculated window value. The apparatus and method reduce the necessary size of a memory unit for storing a hopping sequence.

### PRIORITY

This application claims the benefit under 35 U.S.C. §119(a) of a Korean patent application filed with the Korean Intellectual Property Office on Mar. 9, 2007 and assigned Serial No. 2007-23524, the entire disclosure of which is hereby incorporated by reference.

### BACKGROUND OF THE INVENTION

1. Field of the Invention

The present invention relates to a communication system. More particularly, the present invention relates to a method and apparatus for generating a sequence corresponding to seed values in a communication system.

2. Description of the Related Art

In next generation communication systems, research is actively being conducted to provide users with high-speed services having various Qualities of Services (QoS). Specifically, research is actively being conducted to develop a new type of communication system for ensuring mobility and QoS in a broadband wireless access (BWA) communication system, such as a wireless local area network (WLAN) system and a wireless metropolitan area network (WMAN) system, in order to support a high speed service. Representative of such next generation communication systems are the Institute of Electrical and Electronics Engineers (IEEE) 802.16a/d communication system and the IEEE 802.16e communication system.

The IEEE 802.16a/d and the IEEE 802.16e communication systems employ an orthogonal frequency division multiplexing/orthogonal frequency division multiple access (OFDM/OFDMA) scheme for a physical channel of the WMAN system in order to support a broadband transmission network. The IEEE 802.16a/d communication system considers only the fixed state of a subscriber station (SS), that is, a state where mobility of the SS is not taken into account, and considers only a single cell structure. In contrast, the IEEE 802.16e communication system reflects the mobility of an SS in addition to the characteristics of the IEEE 802.16a/d communication system. Hereinafter, an SS having mobility will be referred to as a mobile station (MS).

In a communication system, data transmission/reception between a base station (BS) and an MS may be performed using a frequency that is changed according to a specific hopping pattern, which is defined by a hopping sequence. For example, in a communication system employing a frequency hopping spread spectrum (FHSS) scheme, a carrier frequency is hopped or switched corresponding to each element in a hopping sequence, and data transmission/reception between a BS and an MS is performed through the hopped or switched carrier frequency. As another example, in a communication system employing a time hopping spread spectrum (THSS) scheme, a data transmission frame is divided into a plurality of time slots, certain time slots are selected according to a specific pattern defined by a hopping sequence, and then data transmission/reception between a BS and an MS is performed through the selected time slots. In a communication system using the OFDM/OFDMA, a plurality of users, i.e. MSs, transmit/receive data using sections which are allocated to themselves according to a specific pattern defined by a hopping sequence.

Such a communication system may use a permutation sequence, as an example of a hopping sequence, in which the permutation is defined by a one-to-one correspondence to itself in an ordered list set. In other words, different permutations are obtained by rearranging the order of elements in a set. For example, when there are “M” number of elements in a set, the number of possible permutations is “M! (M factorial),” in which M! is defined by Equation 1 below.

M!=M×(M−1)× . . . ×1, wherein 0!=1 (1)

In a communication system, when various seed values are input to generate a sequence, different permutations are generated depending on the seed values, and permutation sequences are generated according to the generated permutations. For example, in a communication system, when a seed value has a length of S bits, and permutations have a length of “M,” 2^{S} permutations among “M!” permutations are selected for 2^{S} number of all combinable seed values, and the seed values are matched with the selected permutations, respectively. Here, the “S” is set to a value less than or equal to the “M!”.

Conventional permutation sequences according to seed values will now be described with reference to FIG. 1.

FIG. 1 is a view illustrating conventional permutation sequences generated according to seed values. FIG. 1 shows permutation sequences when “M” is “7,” and “S” is “5.”

As described above, since the “S” has 5 bits, that is, S0, S1, S2, S3 and S4, “2⁵=32” permutations among “7!=7×6×5×4×3×2×=5040,” the number of all possible permutations, are selected for “2⁵=32” seed values, and the seed values correspond to the selected permutations, respectively.

In order to use the hopping function, the permutation sequences corresponding to the seed values are stored in both a transmitter and a receiver in the communication system. In this case, as the number “S” of bits for seed values for generating permutations and/or the length “M” of permutations increases, the number of seed values and the number of permutation sequences corresponding thereto increase, thereby increasing the necessary capacities of memories required for storing the permutation sequences in the transmitter and receiver.

### SUMMARY OF THE INVENTION

An aspect of the present invention is to address the above-mentioned problems and/or disadvantages and to provide at least the advantages described below. Accordingly, an aspect of the present invention is to provide a method and apparatus for generating a hopping sequence in a communication system.

Another aspect of the present invention is to provide a method and apparatus for generating different hopping sequences depending on seed values in a communication system.

In accordance with an aspect of the present invention, a method for generating a hopping sequence in a communication system is provided. The method includes, initializing an arrangement sequence having a length equal to the hopping sequence, initializing a shift register, which is used to generate a pseudo-noise (PN) sequence, to a seed value input for generating the hopping sequence, acquiring a window value, which is a result obtained by applying a window to the PN sequence being an output of the shift register, every predetermined window read cycle, swapping an element corresponding to the window value for another element in the arrangement sequence, repeating the acquiring and swapping until all elements in the arrangement sequence have been swapped for each other, and outputting the arrangement sequence as the hopping sequence after a complete of the repeating.

In accordance with another aspect of the present invention, an apparatus for generating a hopping sequence in a communication system is provided. The apparatus includes a pseudo-noise (PN) sequence generator including a shift register for generating a PN sequence, and a controller for initializing an arrangement sequence having a length equal to that of the hopping sequence, for initializing the shift register to a seed value input for generating the hopping sequence, for acquiring a window value, which is a result obtained by applying a window to the PN sequence being an output of the shift register, every predetermined window read cycle, for swapping an element corresponding to the window value for another element in the arrangement sequence, for repeating the acquiring and swapping operation until all elements in the arrangement sequence have been swapped for each other, and for outputting the arrangement sequence as the hopping sequence after a complete of the repeating.

In accordance with other aspect of the present invention, a method for generating a hopping sequence in a communication system is provided. The method includes, initializing a flag arrangement, having a length equal to the hopping sequence, to zero, initializing a shift register, which is used to generate a pseudo-noise (PN) sequence, to a seed value input for generating the hopping sequence, acquiring a window value, which is a result obtained by applying a window to the PN sequence being an output of the shift register, every predetermined window read cycle, when a first element corresponding to the window value in the flag arrangement is zero, changing a first element to one and updating an element of an arrangement sequence, which has a size equal to the hopping sequence, to the window value, repeating the acquiring, changing, and updating until all elements in the arrangement sequence have been updated and outputting the arrangement sequence as the hopping sequence after a complete of the repeating.

In accordance with other aspect of the present invention, an apparatus for generating a hopping sequence in a communication system is provided. The apparatus includes, a pseudo-noise (PN) sequence generator including a shift register for generating a PN sequence, and a controller for initializing a flag arrangement, having a length equal to that of the hopping sequence, to zero, for initializing the shift register to a seed value input for generating the hopping sequence, for acquiring a window value, which is a result obtained by applying a window to the PN sequence being an output of the shift register, every predetermined window read cycle, for changing a first element to one and updating an element in an arrangement sequence having a size equal to the hopping sequence to the window value when a first element corresponding to the window value in the flag arrangement is zero, for repeating the acquiring, changing, and updating step until all elements in the arrangement sequence have been updated, and for outputting the arrangement sequence as the hopping sequence after a complete of the repeating.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a view illustrating conventional permutation sequences generated according to seed values;

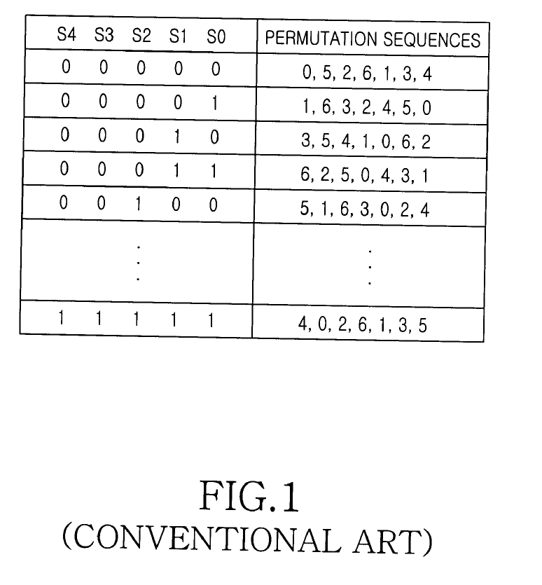

FIG. 2 is a view schematically illustrating the configuration of an apparatus for generating a pseudo-random sequence in a communication system according to an exemplary embodiment of the present invention;

FIG. 3 is a flowchart illustrating a procedure of generating a hopping sequence by a sequence generator in a communication system according to an exemplary embodiment of the present invention;

FIG. 4 is a view illustrating an example of generating a sequence in a communication system according to an exemplary embodiment of the present invention;

FIG. 5 is a view illustrating sequences generated by a sequence generator in a communication system according to an exemplary embodiment of the present invention;

FIG. 6 is a flowchart illustrating a procedure of generating a hopping sequence by a sequence generator in a communication system according to an exemplary embodiment of the present invention;

FIG. 7 is a view schematically illustrating the configuration of an apparatus for generating a sequence in a communication system according to an exemplary embodiment of the present invention; and

FIG. 8 is a view illustrating sequences generated by a sequence generator in a communication system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention refer to a method and apparatus for generating a hopping sequence which represents a hopping pattern of channels, for example, carrier frequencies or time slots, which are used for communication in a communication system. According to an exemplary embodiment of the present invention, described later, when a seed value for generating a hopping sequence is input, a pseudo-random sequence is generated by using the seed value, and a permutation sequence to be used as a hopping sequence is generated by using a result obtained by applying a window having a predetermined size, i.e. a window having a predetermined number of bits, to the generated pseudo-random sequence. As a result, it is possible to reduce the capacities of memories which are required for storing seed values and hopping sequences corresponding to the respective seed values in transmitters and receivers in a communication system.

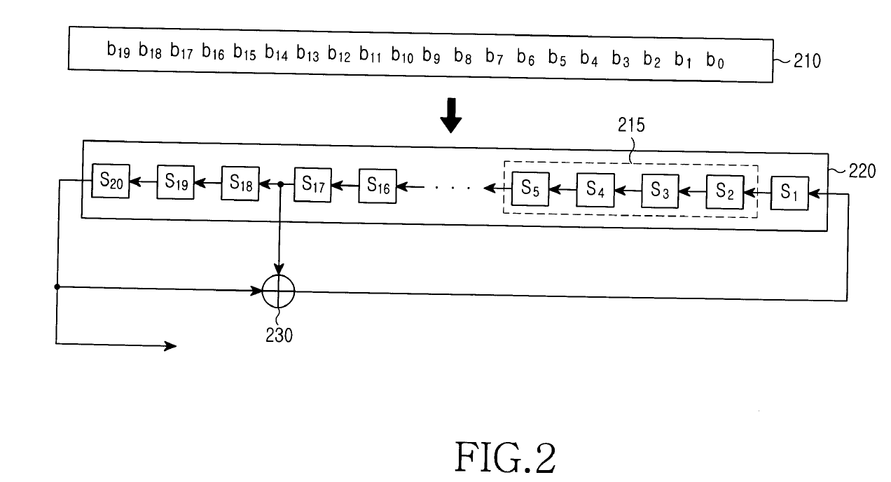

According to an exemplary embodiment of the present invention, described later, a value is read from a circulating shift register of a pseudo-noise (PN) sequence generator, which is initialized to a seed value input to generate a hopping sequence and is operated, by a predetermined window every predetermined read cycle, and a permutation sequence is generated by swapping elements in a sequence arrangement according to the read value. Also, according to another exemplary embodiment of the present invention, described later, a permutation sequence is generated by updating each element in sequence arrangement according to a value which is read from the shift register by a window. Hereinafter, an apparatus for generating a pseudo-random sequence in a communication system according to an exemplary embodiment of the present invention will be described in detail with reference to FIG. 2.

FIG. 2 is a view schematically illustrating the configuration of an apparatus for generating a pseudo-random sequence in a communication system according to an exemplary embodiment of the present invention. That is, FIG. 2 illustrates a PN sequence generator which generates a PN sequence as a pseudo-random sequence corresponding to a seed value having a predetermined number of bits when the seed value has been input to generate a hopping sequence.

The PN sequence generator includes, for example, a 20-bit shift register 220 for inputting a 20-bit seed value 210 as an input value, and an exclusive-OR operator 230 for inputting at least one of the outputs of the shift register 220. Each of the shift register elements constituting the shift register 220 receives and stores the output of a corresponding previous stage at every clock cycle, and the output of the shift register at a required time acts as a PN sequence. When the PN sequence generator uses a primitive polynomial of “p(x)+1+x¹⁷+x²⁰” as a generator polynomial, the exclusive-OR operator 230 receives the outputs of elements S₁₇ and S₂₀ among 20 shift register elements constituting the shift register 220, and the output of the exclusive-OR operator 230 returns to element S₁.

When the seed value 210 is input to the shift register 220, the shift register 220 is initialized to the seed value 210. When a window 215 having a size of 4 bits is used, the position of the window 215 is determined in the shift register 220, and the window 215 is applied to the determined position in the shift register 220 of the PN sequence generator. In the illustrated example of FIG. 2, the 4-bit window 215 is positioned to contain elements S₅, S₄, S₃ and S₂ in the 20-bit shift register 220. In this case, element S5 becomes the most significant bit (MSB) of the window 215, and element S₂ becomes the least significant bit (LSB) of the window 215. In addition, a sequence obtained by the window 215 is expressed using 8S₅+4S₄+2S₃+S₂, that is, expressed as a decimal number (hereinafter, referred to as a window value).

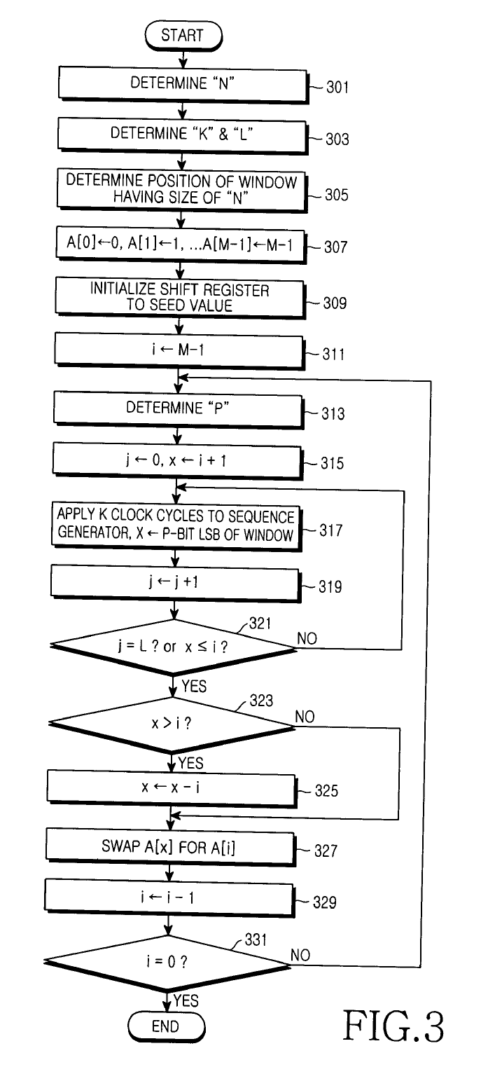

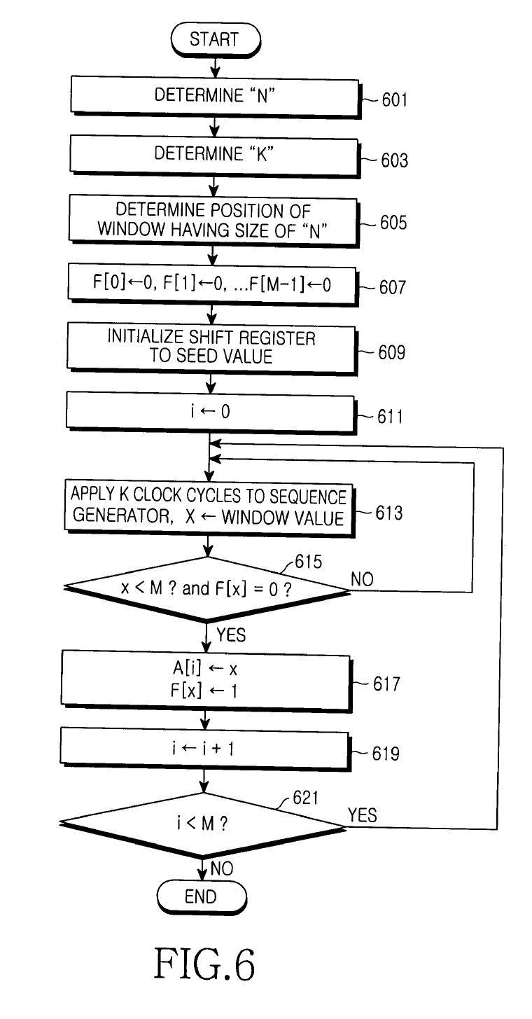

Hereinafter, an exemplary method in which a sequence generator generates a permutation sequence by swapping elements in a sequence arrangement according to a result obtained by applying a window to the output of a shift register of a PN sequence generator in a communication system will be described with reference to FIGS. 3 to 5. Furthermore, an exemplary method of generating a permutation sequence by updating each element in a sequence arrangement according to the result obtained through the application of the window will be described with reference to FIGS. 6 to 8. Here, although not illustrated, the sequence generator further includes a controller for performing operations described below, in addition to the PN sequence generator shown in FIG. 2.

FIG. 3 is a flowchart illustrating a procedure of generating a hopping sequence by a sequence generator in a communication system according to an exemplary embodiment of the present invention. The following description will be given about a procedure of initializing, when a seed value to generate a sequence has been input, a sequence arrangement according to the seed value, applying a window to the seed value, swapping elements in the sequence arrangement according to a result of the application of the window, and generating a hopping sequence. For convenience of description, the following description will be given about a case where, when an S-bit seed value has been input, a sequence having a length of M bits is generated through a sequence generator including an S-bit shift register.

Referring to FIG. 3, when an S-bit seed value has been input to generate a sequence, the sequence generator determines the size of a window for the seed value, that is, determines the value of “N,” which is the number of bits for the window, in step 301. Here, “N” is defined as the lowest integer satisfying Equation 2 below.

M≦2ⁿ (2)

In Equation 2, “M” is a positive integer, and represents the size of a hopping sequence, that is, the size of a permutation sequence, which is generated as described above by the sequence generator.

In step 303, the sequence generator determines the value of parameter “K” (positive integer) representing a cycle for reading a window value from a window positioned in a shift register of the sequence generator, and the value of parameter “L” for determining the number of repetition times of an operation, described later, to generate a sequence, that is, determining the number of swapping times of values in sequence arrangement. In this case, the value the “K” is determined to be a value to minimize correlation between permutations generated by various seed values.

The sequence generator determines a position of an n-bit window in the shift register in step 305. In step 307, the sequence generator initializes a sequence arrangement having a size of “M,” which is used as an intermediate storing means to determine a permutation sequence. That is, the values of elements A[0], A[1], . . . . A[M−1] in sequence arrangement are initialized to A[0]=0, A[1]=1, . . . , A[M−1]=M−1. Then, the sequence generator initializes the shift register to the S-bit seed value in step 309, sets counter variable “i” to “M−1” in step 311, and repeats a sequence generating operation (steps 313 to 331) described below until “i” has a value of zero.

In step 313, the sequence generator determines the number “p” of LSBs to be read from a window to be the lowest integer which satisfies Equation 3 below according to the counter variable.

i<2^{p} (3)

In step 315, the sequence generator sets swapping variable “j” to zero, and initializes output variable “x” to “i+1” according to the “i.” In step 317, as clock cycles are applied to the sequence generator, the shift register and the exclusive-OR operator operate according to the clock cycles, PN sequences are consecutively generated, and when K number of clock cycles are applied, an LSB value of p bits read by the window disposed at the determined position, among PN sequences which are the outputs of the shifter register, is stored as a value of output variable “x.” Then, the sequence generator increases the value of swapping variable “j” by one in step 319.

In step 321, the sequence generator compares the value of swapping variable “j” with the value of parameter “L,” and compares the value of output variable “x” with the value of counter variable “i.” When it is determined in step 321 that the value of swapping variable “j” reaches the value of parameter “L,” or that the value of output variable “x” is equal to or less than the value of counter variable “i,” that is, when at least one of the two conditions is satisfied, the sequence generator proceeds to step 323. In contrast, when both conditions are not satisfied, the sequence generator proceeds to step 317. In step 317, as clock cycles are applied to the sequence generator, the shift register and the exclusive-OR operator operate according to the clock cycles, and when K number of clock cycles are applied, that is, when the next K number of clock cycles are applied, the sequence generator stores an LSB value of p bits in the window disposed at the determined position as a value of output variable “x.” Until at least one of the two conditions is satisfied in step 321, steps 317 to 321 described above are repeatedly performed.

When at least one of the two conditions is satisfied, the sequence generator compares the value of output variable “x” with the value of counter variable “i” in step 323. When it is determined that the value of output variable “x” is larger than the value of counter variable “i” as a result of the comparison, the sequence generator sets the value of output variable “x” to “x−i” in step 325, swaps elements, i.e., A[x] corresponding to output variable “x” and A[1] corresponding to counter variable “i” for each other, in the sequence arrangement in step 327, and proceeds to step 329. In contrast, when it is determined that the value of output variable “x” is equal to or less than the value of counter variable “i” as a result of the comparison of step 323, the sequence generator directly proceeds to step 327, in which the sequence generator swaps elements A[x] and A[1] in the sequence arrangement, without changing the value of output variable “x.”

Next, the sequence generator decreases the value of counter variable “i” by one in step 329, and determines whether to repeatedly perform the aforementioned sequence generating operation by determining if the value of counter variable “i” reaches zero in step 331. When it is determined in step 331 that the value of counter variable “i” is not zero, the sequence generator returns to step 313 in order to repeatedly perform the aforementioned sequence generating operation, in which the sequence generator determines the size “p” of LSBs of a window, which satisfy Equation 3 according to the counter variable. Meanwhile, when it is determined in step 331 that the value of counter variable “i” reaches zero, the sequence generator determines values stored in the sequence arrangement A[0], A[1], . . . , A[M−1] to be a permutation sequence, and terminates the operation. Then, the permutation sequence is used as a hopping sequence to indicate a hopping pattern for communication between an MS and a BS, and communication between the MS and the BS is performed through carrier frequencies or time slots indicated by the respective elements in the hopping sequence.

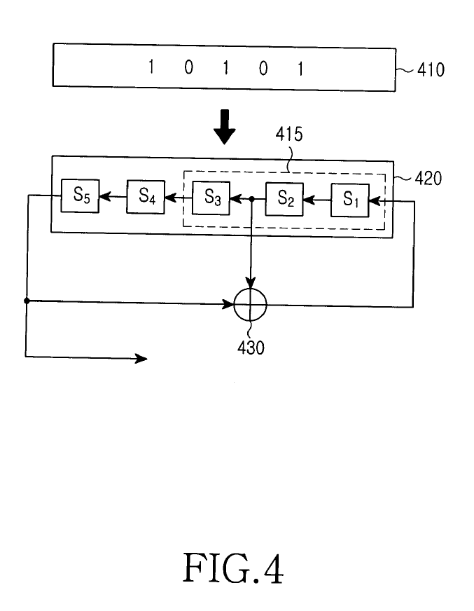

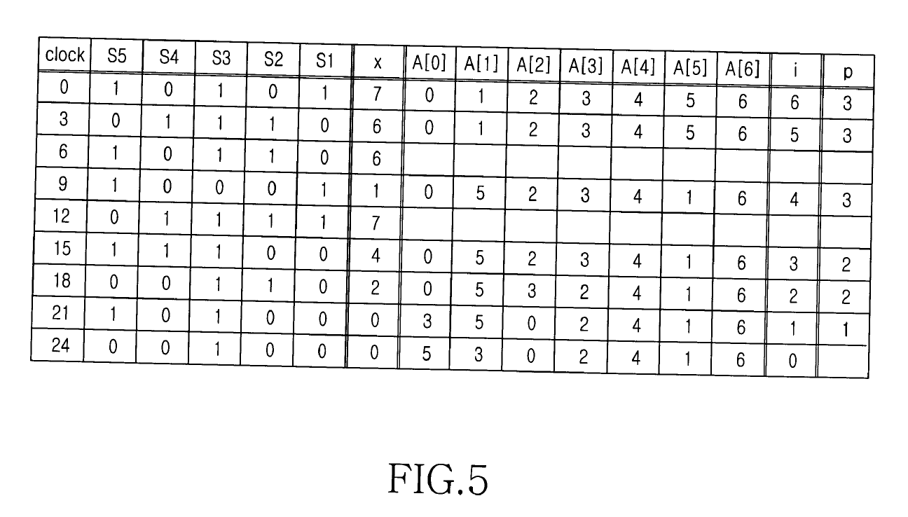

The procedure of generating a sequence through the operation as shown in FIG. 3 in a communication system according to an exemplary embodiment of the present invention will now be described in more detail with reference to FIGS. 4 and 5.

FIG. 4 is a view illustrating an example of generating a sequence in a communication system according to an exemplary embodiment of the present invention. The following description of FIG. 4 will be given about a case where a 4-bit seed value (i.e. S=4) is input, and a sequence having a size of “7” (i.e. M=7) is generated.

A sequence generator includes a 5-bit shift register 420 having an input of a 5-bit seed value 410 of {1, 0, 1, 0, 1} as an initial input, and an exclusive-OR operator 430 for inputting at least one of the outputs of the shift register 420 as an input value. When a primitive polynomial of “p(x) 1+x²+x⁵” is used as a PN generator polynomial, the outputs of elements S₂ and S₅ among 5 shift register elements constituting the shift register 420 are input to the exclusive-OR operator 430, and the output of the exclusive-OR operator 430 returns to element S₁.

When the seed value 410 is input to the shift register 420, the shift register 420 is initialized to the seed value 410. When a window 415 having a size of 3 bits is used, the position of the window 415 is determined in the shift register 420, and the window 415 is applied to the determined position in the shift register 420 of the sequence generator. For example, the 3-bit window 415 is positioned to contain elements S₃, S₂ and S₁ in the 5-bit shift register 420. In this case, element S₃ becomes the MSB of the window 415, and element S₁ becomes the LSB of the window 415. In addition, a sequence obtained by the window 415 is expressed as 4S₃+2S₂+S₁, as a decimal number (i.e. a window value).

FIG. 5 is a view illustrating sequences generated by a sequence generator in a communication system according to an exemplary embodiment of the present invention. That is, FIG. 5 shows sequences generated using the configuration of FIG. 4, and the following description of FIG. 5 will be given using the procedure of FIG. 3, for convenience of description. Cycle “K” for reading a window value from a window is set to three clock cycles, and parameter “L” for determining the number of swapping times of values in sequence arrangement is set to two.

At clock cycle 0, {1, 0, 1, 0, 1} is input as a seed value of {S₅, S₄, S₃, S₂, S₁}, and the sequence generator determines the number “N” of bits for a window, which satisfies Equation 2, as three in step 301. Then, the sequence generator determines the values of “K” and “L” as three and two, respectively, in step 303, and determines the position of a 3-bit window to contain elements S₃, S₂ and S₁, as shown in FIG. 4, in step 305.

In step 307, the arrangement of a sequence having a size of “M=7” is initialized. That is, the values of elements A[0], A[1], . . . , A[6] in the sequence arrangement are initialized to A[0]=0, A[1]=1, . . . , A[6]=6. Then, the sequence generator initializes the shift register to the seed value {1, 0, 1, 0, 1} in step 309, sets counter variable “i” to six in step 311, and determines the size “p” of LSBs, which satisfy Equation 3, in a window to be three in step 313.

In step 315, the sequence generator sets swapping variable “j” to zero, and sets output variable “x” to “7” based on the counter variable of “i=6.” In step 317, as clock cycles are applied to the sequence generator, the shift register 420 and the exclusive-OR operator 430 operate according to the clock cycles, wherein when the third clock cycle is applied, a value of six, obtained by calculating 4S₃+2S₂+S₁, which is a decimal value of three LSBs, i.e., S₃, S₂ and S₁, read by the window from among the outputs of the shift register, is stored as the value of output variable “x.” Next, the sequence generator increases the value of swapping variable “j” to one in step 319. Then, the sequence generator compares the value j=1) of swapping variable “j” with the value (L=2) of parameter “L,” and compares the value (x=6) of output variable “x” with the value (i=6) of counter variable “i” in step 321.

Since it is determined that the value (x=6) of output variable “x” is equal to the value (i=6) of counter variable “i” as a result of the comparison of step 321, the sequence generator proceeds to step 323. Next, since it is determined that the value (x=6) of output variable “x” is not larger than the value (i=6) of counter variable “i” as a result of the comparison of step 323, the sequence generator proceeds to step 327. In step 327, among the elements in the sequence arrangement, A[6] corresponding to the value (x=6) of output variable “x” and A[6] corresponding to the value (i=6) of counter variable “i” are swapped for each other. In this case, since an element would be swapped for itself, it is meaningless and the swapping is not performed. Next, the sequence generator sets the value of “i” to five in step 329, determines if the value of “i” is zero in step 331, and returns to step 313 because it is determined in step 331 that the value of “i” is not zero. In step 313, the sequence generator determines the size “p” of LSBs of a window, which satisfy Equation 3, to be three.

Again, in step 315, the sequence generator sets swapping variable “j” to zero, and sets output variable “x” to “6” based on the counter variable of “i=5.” In step 317, when three clock cycles are consecutively applied, and thus the sixth clock cycle is applied to the sequence generator, six, obtained by 4S₃+2S₂+S₁, which is a decimal value of three LSBs, i.e., S₃, S₂ and S₁, read by the window, is stored as the value of output variable “x.” Next, the sequence generator increases the value of swapping variable “j” to one in step 319. Then, in step 321, the sequence generator compares the value (j=1) of swapping variable “j” with the value (L=2) of parameter “L,” and compares the value (x=6) of output variable “x” with the value (i=5) of counter variable “i.”

Since it is determined in step 321 that the value (j=1) of swapping variable “j” is different from the value (L=2) of parameter “L,” and that the value (x=6) of output variable “x” is larger than the value (i=5) of counter variable “i,” the sequence generator proceeds to step 317. In step 317, when the ninth clock cycle is applied to the sequence generator after two clock cycles are additionally applied thereto, one, obtained by 4S₃+2S₂+S₁, which is a decimal value of three LSBs, i.e., S₃, S₂ and S₁, read by the window, is stored as the value of output variable “x.” Next, the sequence generator increases the value of swapping variable “j” to two in step 319. Then, in step 321, the sequence generator compares the value (j=2) of swapping variable “j” with the value (L=2) of parameter “L,” and compares the value (x=1) of output variable “x” with the value (i=5) of counter variable “i.”

Since it is determined in step 321 that the value of swapping variable “j” is equal to the value of parameter “L”, and that the value of output variable “x” is less than the value of counter variable “i”, the sequence generator proceeds to step 323. Next, since it is determined in step 323 that the value of output variable “x” is less than the value of counter variable “i”, the sequence generator proceeds to step 327. In step 327, among the elements in the sequence arrangement, A[1] corresponding to the value (x=1) of output variable “x” and A[5] corresponding to the value (i=5) of counter variable “i” are swapped for each other. Next, the sequence generator sets the value of “i” to four in step 329, determines if the value of “i” is zero in step 331, and returns to step 313 because it is determined in step 331 that the value of “i” is not zero. In step 313, the sequence generator determines the size “p” of LSBs of a window, which satisfy Equation 3, to be three.

Again, in step 315, the sequence generator sets swapping variable “j” to zero, and sets output variable “x” to “5” based on the counter variable of “i=4.” In step 317, when the 12^{th} clock cycle is applied to the sequence generator after two clock cycles are additionally applied thereto, seven, obtained by 4S₃+2S₂+S₁, which is a decimal value of three LSBs, i.e., S₃, S₂ and S₁, read by the window, is stored as the value of output variable “x.” Next, the sequence generator increases the value of swapping variable “j” to one in step 319. Then, in step 321, the sequence generator compares the value (j=1) of swapping variable “j” with the value (L=2) of parameter “L,” and compares the value (x=7) of output variable “x” with the value (i=4) of counter variable “i.”

Since it is determined in step 321 that the value of swapping variable “j” is different from the value of parameter “L,” and that the value of output variable “x” is larger than the value of counter variable “i,” the sequence generator proceeds to step 317. In step 317, when the 15^{th} clock cycle is applied to the sequence generator after two clock cycles are additionally applied thereto, four, obtained by 4S₃+2S₂+S₁, which is a decimal value of three LSBs, i.e., S₃, S₂ and S₁, read by the window, is stored as the value of output variable “x.” Next, the sequence generator increases the value of swapping variable “j” to two in step 319. Then, in step 321, the sequence generator compares the value (j=2) of swapping variable “j” with the value (L=2) of parameter “L,” and compares the value (x=4) of output variable “x” with the value (i=4) of counter variable “i.”

Since it is determined in step 321 that the value of swapping variable “j” is equal to the value of parameter “L”, and that the value of output variable “x” is less than the value of counter variable “i”, the sequence generator proceeds to step 323. Next, since it is determined in step 323 that the value of output variable “x” is equal to the value of counter variable “i”, the sequence generator proceeds to step 327. In step 327, among the elements in the sequence arrangement, A[4] corresponding to the value (x=4) of output variable “x” and A[4] corresponding to the value (i=4) of counter variable “i” are swapped for each other. In this case, since an element would be swapped for itself, it is meaningless and the swapping is not performed. Next, the sequence generator sets the value of “i” to three in step 329, determines if the value of “i” is zero in step 331, and returns to step 313 because it is determined in step 331 that the value of “i” is not zero. In step 313, the sequence generator determines the size “p” of LSBs of a window, which satisfy Equation 3, to be two.

Again, in step 315, the sequence generator sets swapping variable “j” to zero, and sets output variable “x” to “4” based on the counter variable of “i=3.” In step 317, when the 18^{th} clock cycle is applied to the sequence generator after two clock cycles are additionally applied thereto, two, obtained by 2S₂+S₁, which is a decimal value of two LSBs, i.e., S₂ and S₁, read by the window, is stored as the value of output variable “x.” Next, the sequence generator increases the value of swapping variable “j” to one in step 319. Then, in step 321, the sequence generator compares the value (j=1) of swapping variable “j” with the value (L=2) of parameter “L,” and compares the value (x=2) of output variable “x” with the value (i=3) of counter variable “i.”

Since it is determined in step 321 that the value of output variable “x” is less than the value of counter variable “i”, the sequence generator proceeds to step 323. Next, since it is determined in step 323 that the value of output variable “x” is less than the value of counter variable “i”, the sequence generator proceeds to step 327. In step 327, among the elements in the sequence arrangement, A[2] corresponding to the value (x=2) of output variable “x” and A[3] corresponding to the value (i=3) of counter variable “i” are swapped for each other. Next, the sequence generator sets the value of “i” to two in step 329, and determines if the value of “i” is zero in step 331, and returns to step 313 because it is determined in step 331 that the value of “i” is not zero. In step 313, the sequence generator determines the size “p” of LSBs of a window, which satisfy Equation 3, to be one.

Again, in step 315, the sequence generator sets swapping variable “j” to zero, and sets output variable “x” to “3” based on the counter variable of “i=2.” In step 317, when the 21^{st} clock cycle is applied to the sequence generator after two clock cycles are additionally applied thereto, zero, obtained by S₁, which is a decimal value of one LSB, i.e., S₁, read by the window, is stored as the value of output variable “x.” Next, the sequence generator increases the value of swapping variable “j” to one in step 319. Then, in step 321, the sequence generator compares the value (j=1) of swapping variable “j” with the value (L=2) of parameter “L,” and compares the value (x=0) of output variable “x” with the value (i=2) of counter variable “i.”

Since it is determined in step 321 that the value of output variable “x” is less than the value of counter variable “i”, the sequence generator proceeds to step 323. Next, since it is determined in step 323 that the value of output variable “x” is less than the value of counter variable “i”, the sequence generator proceeds to step 327. In step 327, among the elements in the sequence arrangement, A[0] corresponding to the value (x=0) of output variable “x” and A[2] corresponding to the value (i=2) of counter variable “i” are swapped for each other. Next, the sequence generator sets the value of “i” to one in step 329, and determines if the value of “i” is zero in step 331, and returns to step 313 because it is determined in step 331 that the value of “i” is not zero. In step 313, the sequence generator determines the size “p” of LSBs of a window, which satisfy Equation 3, to be one.

Again, in step 315, the sequence generator sets swapping variable “j” to zero, and sets output variable “x” to “2” based on the counter variable of “i=1.” In step 317, when the 24^{th} clock cycle is applied to the sequence generator after two clock cycles are additionally applied thereto, zero obtained by S₁, which is a decimal value of one LSB, i.e., S₁, read by the window, is stored as the value of output variable “x.” Next, the sequence generator increases the value of swapping variable “j” to one in step 319. Then, in step 321, the sequence generator compares the value (j=1) of swapping variable “j” with the value (L=2) of parameter “L,” and compares the value (x=0) of output variable “x” with the value (i=1) of counter variable “i.”

Since it is determined in step 321 that the value of output variable “x” is less than the value of counter variable “i”, the sequence generator proceeds to step 323. Next, since it is determined in step 323 that the value of output variable “x” is less than the value of counter variable “i”, the sequence generator proceeds to step 327. In step 327, among the elements in the sequence arrangement, A[0] corresponding to the value (x=0) of output variable “x” and A[1] corresponding to the value (i=1) of counter variable “i” are swapped for each other. Next, the sequence generator sets the value of “i” to zero in step 329, and determines if the value of “i” is zero in step 331.

Since it is determined that the value of “i” is zero as a result of the determination in step 331, the sequence generating operation is terminated, and a permutation sequence of {5, 3, 0, 2, 4, 1, 6} according to the seed value of {1, 0, 1, 0, 1} input for sequence generation is generated from the values finally stored in the sequence arrangement A[0], A[1], . . . , A[6], that is, A[0]=5, A[1]=3, . . . , A[6]=6. The generated permutation sequence is used as a hopping sequence for communication between the MS and the BS.

Hereinafter, a method in which a sequence generator generates a permutation sequence by updating a flag arrangement and a sequence arrangement according to a result obtained by applying a window to the outputs of a shift register of a PN sequence generator in a communication system according to an exemplary embodiment of the present invention will be described in more detail with reference to FIGS. 6 to 8.

FIG. 6 is a flowchart illustrating a procedure of generating a hopping sequence by a sequence generator in a communication system according to an exemplary embodiment of the present invention. As will be described, an exemplary embodiment includes a procedure of initializing, when a seed value to generate a sequence has been input, a flag arrangement according to the seed value, applying a window to the seed value, updating the flag arrangement and sequence arrangement according to a result of the application of the window, and generating a hopping sequence. For convenience only, in the following description of an exemplary implementation, when an S-bit seed value has been input, a sequence having a length of M bits is generated through a sequence generator including an S-bit shift register.

Referring to FIG. 6, when an S-bit seed value has been input to generate a sequence, the sequence generator determines the size of a window for the seed value, that is, determines the value of “N,” which is the number of bits for the window, in step 601. Here, “N” is defined as the lowest integer satisfying Equation 2.

In step 603, the sequence generator determines the value of parameter “K” (positive integer) representing a period for reading a window value from a window positioned in a shift register of the sequence generator. In this case, the value “K” is determined to be a value so as to minimize any correlation between permutations generated by various seed values.

The sequence generator determines a position of an n-bit window in the shift register in step 605. In step 607, the sequence generator initializes flag arrangement having a length of “M,” which is used to determine a permutation sequence, to zero. That is, the values of elements F[0], F[1], . . . , F[M−1] in the flag arrangement are initialized to F[0]=0, F[1]=0, . . . , F[M−1]=0. Then, the sequence generator initializes the shift register to the S-bit seed value in step 609, sets counter variable “i” to zero in step 611, and repeats a sequence generating operation (steps 613 to 621) described below until the value of “i” is less than the value of the “M.”

In detail, in step 613, as clock cycles are applied to the sequence generator, the shift register and an exclusive-OR operator operate to consecutively generate PN sequences, in which when K number of clock cycles are applied to the sequence generator, a value read by an n-bit window disposed at the predetermined position, among values of the shift register, is stored as the value of output variable “x.” In step 615, the sequence generator compares the value of output variable “x” with the length “M” of the permutation sequence, and determines if F[x] corresponding to the output variable “x,” among elements in the flag arrangement, has a value of zero. When the value of output variable “x” is less than the length “M” of the sequence, and F[x] has a value of zero, that is, when both conditions are satisfied, the sequence generator proceeds to step 617. In contrast, when either condition is not satisfied, the sequence generator returns to step 613. When the sequence generator returns to step 613, another K number of clock cycles are applied to the sequence generator, wherein when the next K^{th} clock cycle is applied to the sequence generator, a corresponding n-bit window value is again stored as the output variable “x.” Steps 613 and 615 described above are repeated until both conditions are satisfied.

When both conditions are satisfied, the sequence generator stores the value of output variable “x” in A[i] corresponding to the counter variable “i,” among elements in the sequence arrangement, and sets F[x], corresponding to the output variable “x” among elements in the flag arrangement, to one in step 617. The sequence generator updates the value of counter variable “i” to “i+1” in step 619, and determines if the value of counter variable “i” is less than the length “M” of the sequence in step 621. When it is determined in step 621 that the value of counter variable “i” is less than the length “M” of the sequence, the sequence generator returns to step 613 in order to repeat the aforementioned sequence generating operation. In contrast, when it is determined that the value of counter variable “i” is equal to or larger than the length “M” of the sequence, the sequence generating operation is terminated, and the values stored in the sequence arrangement A[0], A[1], . . . , A[M−1] are determined as a permutation sequence. Then, the permutation sequence is used as a hopping sequence to indicate a hopping pattern for communication between an MS and a BS, and communication between the MS and the BS is performed through carrier frequencies or time slots indicated by the respective elements in the hopping sequence.

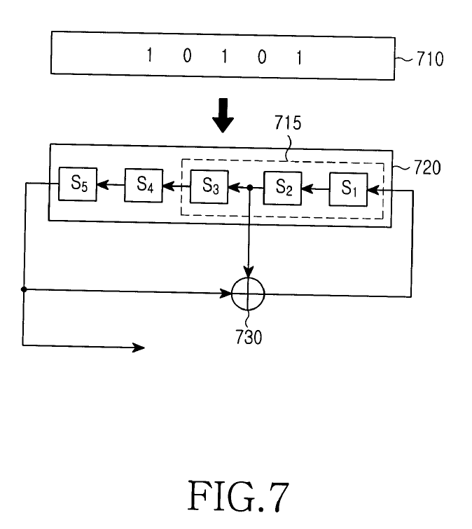

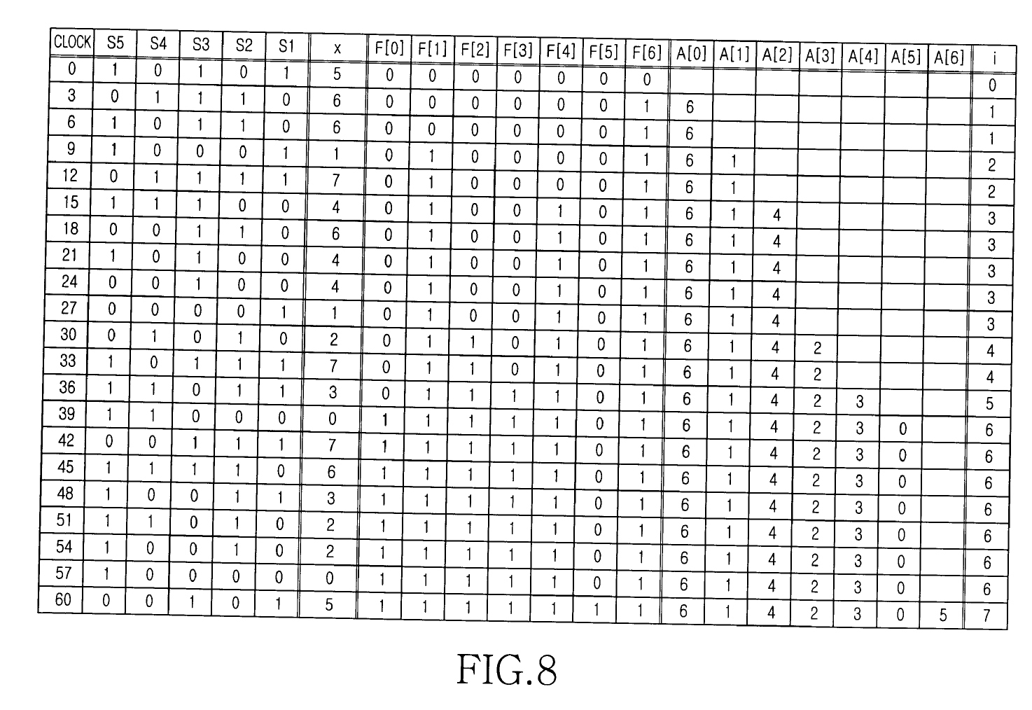

A procedure of generating a sequence through the operation as shown in FIG. 6 in a communication system according to an exemplary embodiment of the present invention will now be described in more detail with reference to FIGS. 7 and 8.

FIG. 7 is a view showing an example of generating a sequence in a communication system according to an exemplary embodiment of the present invention. The following description of FIG. 7 will be given about an exemplary case where a 4-bit seed value (i.e. S=4) is input, and a sequence having a size of “7” (i.e. M=7) is generated.

A sequence generator includes a 5-bit shift register 720 having an input of a 5-bit seed value 710 of {1, 0, 1, 0, 1} as an initial input, and an exclusive-OR operator 730 for inputting at least one of the outputs of the shift register 720 as an input value. When a primitive polynomial of “p(x) 1+x²+x⁵” is used as a PN generator polynomial, the outputs of elements S₂ and S₅ among 5 shift register elements constituting the shift register 720 are input to the exclusive-OR operator 730, and the output of the exclusive-OR operator 730 returns to element S₁.

When the seed value 710 is input to the shift register 720, the shift register 720 is initialized to the seed value 710. When a window 715 having a size of 3 bits is used, the position of the window 715 is determined in the shift register 720, and the window 715 is applied to the determined position in the shift register 720 of the sequence generator. For example, the 3-bit window 715 is positioned to contain elements S₃, S₂ and S₁ in the 5-bit shift register 720. In this case, element S₃ becomes the MSB of the window 715, and element S₁ becomes the LSB of the window 715. In addition, a value obtained by the window 715 is expressed as 4S₃+2S₂+S₁, as a decimal number (i.e. a window value).

FIG. 8 is a view illustrating sequences generated by a sequence generator in a communication system according to an exemplary embodiment of the present invention. That is, FIG. 8 shows sequences generated using the configuration of FIG. 7, and the following description of FIG. 8 will be given using the procedure of FIG. 6, for convenience of description. The value of “K” for reading a window value from the window is set to three clock cycles.

At clock cycle 0, {1, 0, 1, 0, 1} is input as a seed value of {S5, S4, S3, S2, S1}, and the sequence generator determines the number “N” of bits for a window, which satisfies Equation 2, as three in step 601. Then, the sequence generator determines the value of “K” as three in step 603, and determines the position of a 3-bit window to contain elements S₃, S₂ and S₁, as shown in FIG. 7, in step 605.

In step 607, the arrangement of flags having a size of “M=7” is initialized. That is, the values of elements F[0], F[1], . . . , F[6] in the flag arrangement are initialized to F[0]=0, F[1]=0, . . . , F[6]=0. Then, the sequence generator initializes the shift register to the seed value {1, 0, 1, 0, 1} in step 609, and sets counter variable “i” to zero in step 611.

In step 613, as clock cycles are applied to the sequence generator, the shift register 720 and the exclusive-OR operator 730 operate according to the clock cycles, wherein when the third clock cycle is applied, six, obtained by 4S₃+2S₂+S₁, which is a decimal value of a 3-bit sequence, i.e., {S₃, S₂, S₁}, read by the position-determined window from among the outputs of the shift register, is stored as the value of output variable “x.”

In step 615, the sequence generator compares the value (x=6) of output variable “x” with the length (M=7) of the sequence, and determines if F[6] corresponding to the value (x=6) of output variable “x” has a value of zero. Since it is determined that the value of output variable “x” is less than the length “M” of the sequence, and that F[6] has a value of zero, as a result of the comparison and determination in step 615, the sequence generator proceeds to step 617. In step 617, the value (x=6) of output variable “x” is stored in A[0] corresponding to the value (i=0) of counter variable “i,” among elements in the sequence arrangement, and F[6] corresponding to the value (x=6) of output variable “x,” among elements in the flag arrangement, is set to one.

Then, the sequence generator increases the value of counter variable “i” to one in step 619, determines if the value (i=1) of counter variable “i” is less than the length (M=7) of the sequence in step 621, and proceeds to step 613 because the value of the counter variable “i” is less than the length “M” of the sequence. In step 613, when clock cycles are applied to the sequence generator, and the sixth clock cycle is applied thereto, six obtained by 4S₃+2S₂+S₁, which is a decimal value of sequence {S₃, S₂, S₁} read by the window, is stored as the value of output variable “x.”

Next, in step 615, the sequence generator compares the value (x=6) of output variable “x” with the length (M=7) of the sequence, and determines if F[6] corresponding to the value (x=6) of output variable “x” has a value of zero. Since it is determined that the value of F[6] is not zero as a result of the comparison and determination in step 615, the sequence generator proceeds to step 613. In step 613, when clock cycles are applied to the sequence generator, and the ninth clock cycle is applied thereto, one, obtained by 4S₃+2S₂+S₁, which is a decimal value of sequence {S₃, S₂, S₁} read by the window, is stored as the value of output variable “x.”

In step 615, the sequence generator compares the value (x=1) of output variable “x” with the length (M=7) of the sequence, and determines if F[1] corresponding to the value (x=1) of output variable “x” has a value of zero. Since it is determined that the value of output variable “x” is less than the length “M” of the sequence, and that F[1] has a value of zero, as a result of the comparison and determination in step 615, the sequence generator proceeds to step 617. In step 617, the value (x=1) of output variable “x” is stored in A[1] corresponding to the value (i=1) of counter variable “i,” in the sequence arrangement, and F[1] corresponding to the value (x=1) of output variable “x,” in the flag arrangement, is set to one.

Then, the sequence generator increases the value of counter variable “i” to two in step 619, determines if the value (i=2) of counter variable “i” is less than the length (M=7) of the sequence in step 621, and proceeds to step 613 because the value of the counter variable “i” is less than the length “M” of the sequence. In step 613, when clock cycles are applied to the sequence generator, and the 12^{th} clock cycle is applied thereto, seven obtained by 4S₃+2S₂+S₁, which is a decimal value of sequence {S₃, S₂, S₁} read by the window, is stored as the value of output variable “x”.

Next, in step 615, the sequence generator compares the value (x=7) of output variable “x” with the length (M=7) of the sequence, and determines if F[7] corresponding to the value (x=7) of output variable “x” has a value of zero. Since it is determined that the value of output variable “x” is equal to the length “M” of the sequence as a result of the comparison and determination in step 615, the sequence generator proceeds to step 613. In step 613, when clock cycles are applied to the sequence generator, and the 15^{th} clock cycle is applied thereto, four, obtained by 4S₃+2S₂+S₁, which is a decimal value of sequence {S₃, S₂, S₁} read by the window, is stored as the value of output variable “x.”

In step 615, the sequence generator compares the value (x=4) of output variable “x” with the length (M=7) of the sequence, and determines if F[4] corresponding to the value (x=4) of output variable “x” has a value of zero. Since it is determined that the value of output variable “x” is less than the length “M” of the sequence, and that F[4] has a value of zero, as a result of the comparison and determination in step 615, the sequence generator proceeds to step 617. In step 617, the value (x=4) of output variable “x” is stored in A[2] corresponding to the value (i=2) of counter variable “i,” in the sequence arrangement, and F[4] corresponding to the value (x=4) of output variable “x,” in the flag arrangement, is set to one.

Then, the sequence generator increases the value of counter variable “i” to three in step 619, determines if the value (i=3) of counter variable “i” is less than the length (M=7) of the sequence in step 621, and proceeds to step 613 because the value of the counter variable “i” is less than the length “M” of the sequence. In step 613, when clock cycles are applied to the sequence generator, and the 18^{th} clock cycle is applied thereto, six, obtained by 4S₃+2S₂+S₁, which is a decimal value of sequence {S₃, S₂, S₁} read by the window, is stored as the value of output variable “x”.

Next, in step 615, the sequence generator compares the value (x=6) of output variable “x” with the length (M=7) of the sequence, and determines if F[6] corresponding to the value (x=6) of output variable “x” has a value of zero. Since it is determined that the value of F[6] is not zero as a result of the comparison and determination in step 615, the sequence generator proceeds to step 613. In step 613, when clock cycles are applied to the sequence generator, and the 21^{st} clock cycle is applied thereto, four, obtained by 4S₃+2S₂+S₁, which is a decimal value of sequence {S₃, S₂, S₁} read by the window, is stored as the value of output variable “x.”

Next, in step 615, the sequence generator compares the value (x=4) of output variable “x” with the length (M=7) of the sequence, and determines if F[4] corresponding to the value (x=4) of output variable “x” has a value of zero. Since it is determined that the value of F[4] is not zero as a result of the comparison and determination in step 615, the sequence generator proceeds to step 613. In step 613, when the 24^{th} clock cycle is applied to the sequence generator, four, obtained by 4S₃+2S₂+S₁, which is a decimal value of sequence {S₃, S₂, S₁} read by the window, is stored as the value of output variable “x.”

Next, in step 615, the sequence generator compares the value (x=4) of output variable “x” with the length (M=7) of the sequence, and determines if F[4] corresponding to the value (x=4) of output variable “x” has a value of zero. Since it is determined that the value of F[4] is not zero as a result of the comparison and determination in step 615, the sequence generator proceeds to step 613. In step 613, when the 27^{th} clock cycle is applied to the sequence generator, one, obtained by 4S₃+2S₂+S₁, which is a decimal value of sequence {S₃, S₂, S₁} read by the window, is stored as the value of output variable “x.”

Next, in step 615, the sequence generator compares the value (x=1) of output variable “x” with the length (M=7) of the sequence, and determines if F[1] corresponding to the value (x=1) of output variable “x” has a value of zero. Since it is determined that the value of F[1] is not zero as a result of the comparison and determination in step 615, the sequence generator proceeds to step 613. In step 613, when the 30^{th} clock cycle is applied to the sequence generator, two, obtained by 4S₃+2S₂+S₁, which is a decimal value of sequence {S₃, S₂, S₁} read by the window, is stored as the value of output variable “x.”

Next, in step 615, the sequence generator compares the value (x=2) of output variable “x” with the length (M=7) of the sequence, and determines if F[2] corresponding to the value (x=2) of output variable “x” has a value of zero. Since it is determined that the value of output variable “x” is less than the length “M” of the sequence, and that F[2] has a value of zero, as a result of the comparison and determination in step 615, the sequence generator proceeds to step 617. In step 617, the value (x=2) of output variable “x” is stored in A[3] corresponding to the value (i=3) of counter variable “i,” in the sequence arrangement, and F[2] corresponding to the value (x=2) of output variable “x,” in the flag arrangement, is set to one.

Then, the sequence generator increases the value of counter variable “i” to four in step 619, determines if the value (i=4) of counter variable “i” is less than the length (M=7) of the sequence in step 621, and proceeds to step 613 because the value of the counter variable “i” is less than the length “M” of the sequence. In step 613, when the 33^{rd} clock cycle is applied to the sequence generator, seven, obtained by 4S₃+2S₂+S₁ which is a decimal value of sequence {S₃, S₂, S₁} read by the window, is stored as the value of output variable “x.”

Next, in step 615, the sequence generator compares the value (x=7) of output variable “x” with the length (M=7) of the sequence, and determines if F[7] corresponding to the value (x=7) of output variable “x” has a value of zero. Since it is determined that the value of output variable “x” is equal to the length “M” of the sequence as a result of the comparison and determination in step 615, the sequence generator proceeds to step 613. In step 613, when the 36^{th} clock cycle is applied to the sequence generator, three, obtained by 4S₃+2S₂+S₁, which is a decimal value of sequence {S₃, S₂, S₁} read by the window, is stored as the value of output variable “x”.

Next, in step 615, the sequence generator compares the value (x=3) of output variable “x” with the length (M=7) of the sequence, and determines if F[3] corresponding to the value (x=3) of output variable “x” has a value of zero. Since it is determined that the value of output variable “x” is less than the length “M” of the sequence, and that F[3] has a value of zero, as a result of the comparison and determination in step 615, the sequence generator proceeds to step 617. In step 617, the value (x=3) of output variable “x” is stored in A[4] corresponding to the value (i=4) of counter variable “i,” in the sequence arrangement, and F[3] corresponding to the value (x=3) of output variable “x,” in the flag arrangement, is set to one.

Then, the sequence generator increases the value of counter variable “i” to five in step 619, determines if the value (i=5) of counter variable “i” is less than the length (M=7) of the sequence in step 621, and proceeds to step 613 because the value of the counter variable “i” is less than the length “M” of the sequence. In step 613, when the 39^{th} clock cycle is applied to the sequence generator, zero, obtained by 4S₃+2S₂+S₁, which is a decimal value of sequence {S₃, S₂, S₁} read by the window, is stored as the value of output variable “x.”

Next, in step 615, the sequence generator compares the value (x=0) of output variable “x” with the length (M=7) of the sequence, and determines if F[0] corresponding to the value (x=0) of output variable “x” has a value of zero. Since it is determined that the value of output variable “x” is less than the length “M” of the sequence, and that F[0] has a value of zero, as a result of the comparison and determination in step 615, the sequence generator proceeds to step 617. In step 617, the value (x=0) of output variable “x” is stored in A[5] corresponding to the value (i=5) of counter variable “i,” in the sequence arrangement, and F[0] corresponding to the value (x=0) of output variable “x,” in the flag arrangement, is set to one.

Then, the sequence generator increases the value of counter variable “i” to six in step 619, determines if the value (i=6) of counter variable “i” is less than the length (M=7) of the sequence in step 621, and proceeds to step 613 because the value of the counter variable “i” is less than the length “M” of the sequence. In step 613, when the 42^{nd} clock cycle is applied to the sequence generator, seven, obtained by 4S₃+2S₂+S₁, which is a decimal value of sequence {S₃, S₂, S₁} read by the window, is stored as the value of output variable “x.”

Next, in step 615, the sequence generator compares the value (x=7) of output variable “x” with the length (M=7) of the sequence, and determines if F[7] corresponding to the value (x=7) of output variable “x” has a value of zero. Since it is determined that the value of output variable “x” is equal to the length “M” of the sequence as a result of the comparison and determination in step 615, the sequence generator proceeds to step 613. In step 613, when the 45^{th} clock cycle is applied to the sequence generator, six, obtained by 4S₃+2S₂+S₁, which is a decimal value of sequence {S₃, S₂, S₁} read by the window, is stored as the value of output variable “x.”

Next, in step 615, the sequence generator compares the value (x=6) of output variable “x” with the length (M=7) of the sequence, and determines if F[6] corresponding to the value (x=6) of output variable “x” has a value of zero. Since it is determined that the value of F[6] is not zero as a result of the comparison and determination in step 615, the sequence generator proceeds to step 613. In step 613, when the 48^{th} clock cycle is applied to the sequence generator, three, obtained by 4S₃+2S₂+S₁, which is a decimal value of sequence {S₃, S₂, S₁} read by the window, is stored as the value of output variable “x.”

Next, in step 615, the sequence generator compares the value (x=3) of output variable “x” with the length (M=7) of the sequence, and determines if F[3] corresponding to the value (x=3) of output variable “x” has a value of zero. Since it is determined that the value of F[3] is not zero as a result of the comparison and determination in step 615, the sequence generator proceeds to step 613. In step 613, when the 51^{st} clock cycle is applied to the sequence generator, two, obtained by 4S₃+2S₂+S₁, which is a decimal value of sequence {S₃, S₂, S₁} read by the window, is stored as the value of output variable “x.”

Next, in step 615, the sequence generator compares the value (x=2) of output variable “x” with the length (M=7) of the sequence, and determines if F[2] corresponding to the value (x=2) of output variable “x” has a value of zero. Since it is determined that the value of F[2] is not zero as a result of the comparison and determination in step 615, the sequence generator proceeds to step 613. In step 613, when the 54^{th} clock cycle is applied to the sequence generator, two, obtained by 4S₃+2S₂+S₁, which is a decimal value of sequence {S₃, S₂, S₁} read by the window, is stored as the value of output variable “x.”

Next, in step 615, the sequence generator compares the value (x=2) of output variable “x” with the length (M=7) of the sequence, and determines if F[2] corresponding to the value (x=2) of output variable “x” has a value of zero. Since it is determined that the value of F[2] is not zero as a result of the comparison and determination in step 615, the sequence generator proceeds to step 613. In step 613, when the 57^{th} clock cycle is applied to the sequence generator, zero, obtained by 4S₃+2S₂+S₁, which is a decimal value of sequence {S₃, S₂, S₁} read by the window, is stored as the value of output variable “x.”

Next, in step 615, the sequence generator compares the value (x=0) of output variable “x” with the length (M=7) of the sequence, and determines if F[0] corresponding to the value (x=0) of output variable “x” has a value of zero. Since it is determined that the value of F[0] is not zero as a result of the comparison and determination in step 615, the sequence generator proceeds to step 613. In step 613, when the 60^{th} clock cycle is applied to the sequence generator, five, obtained by 4S₃+2S₂+S₁, which is a decimal value of sequence {S₃, S₂, S₁} read by the window, is stored as the value of output variable “x.”

Next, in step 615, the sequence generator compares the value (x=5) of output variable “x” with the length (M=7) of the sequence, and determines if F[5] corresponding to the value (x=5) of output variable “x” has a value of zero. Since it is determined that the value of output variable “x” is less than the length “M” of the sequence, and that F[5] has a value of zero, as a result of the comparison and determination in step 615, the sequence generator proceeds to step 617. In step 617, the value (x=5) of output variable “x” is stored in A[6] corresponding to the value (i=6) of counter variable “i,” in the sequence arrangement, and F[5] corresponding to the value (x=5) of output variable “x,” in the flag arrangement, is set to one.

Then, the sequence generator increases the value of counter variable “i” to seven in step 619, determines if the value (i=7) of counter variable “i” is less than the length (M=7) of the sequence in step 621. Since it is determined that the value of counter variable “i” is not less than the length “M” of the sequence as a result of the determination in step 621, the sequence generating operation is terminated, and a permutation sequence of {6, 1, 4, 2, 3, 0, 5} according to the seed value of {1, 0, 1, 0, 1} is generated from the values stored in the sequence arrangement A[0], A[1], . . . , A[6], that is, A[0]=6, A[1]=1, . . . , A[6]=5. The generated permutation sequence is used as a hopping sequence for communication between the MS and the BS.

As described above, according to exemplary embodiments of the present invention, when a seed value for sequence generation is input in a communication system, a window is applied to the seed value, and elements in sequence arrangement are swapped or updated according to a result of the application of the window, thereby generating a permutation sequence to be used as a hopping sequence according to the seed value. Accordingly, is possible to reduce the complexity of the system which is required for generating permutation sequences and storing seed values and sequences corresponding to the seed values.

While the present invention has been shown and described with reference to certain exemplary embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for generating a hopping sequence in a communication system, the method comprising:
initializing an arrangement sequence having a length equal to the hopping sequence;
initializing a shift register, which is used to generate a pseudo-noise (PN) sequence, to a seed value input for generating the hopping sequence;
acquiring a window value, which is a result obtained by applying a window to the PN sequence being an output of the shift register, every predetermined window read cycle;
swapping an element corresponding to the window value for another element in the arrangement sequence;
repeating the acquiring and swapping until all elements in the arrangement sequence have been swapped for each other; and
outputting the arrangement sequence as the hopping sequence after a complete of the repeating.

2. The method as claimed in claim 1, further comprising:
determining a size of the window according to a size of the hopping sequence; and
determining a position to which the window is to be applied in the PN sequence.

3. The method as claimed in claim 2, wherein the size of the window comprises “N” bits, in which “N” is determined to be the lowest integer satisfying M≦2ⁿ according to the size “M” of the hopping sequence.

4. The method as claimed in claim 1, wherein the arrangement sequence is initialized to A[0]=0, A[1]=1, . . . , A[M−1]=M−1, in which A[x] represents each element in the arrangement sequence, and “M” represents the size of the hopping sequence.

5. The method as claimed in claim 1, wherein the window value is determined to be a decimal value corresponding to “p” least significant bits (LSBs) included in the window within the PN sequence, in which “p” is the lowest integer satisfying i<2^{p} according to a counter variable “i,” which is set to “M−1” based on the size “M” of the hopping sequence upon the initialization of the shift register and is then decreased by one whenever the swapping is performed.

6. The method as claimed in claim 5, wherein the swapping comprises:
repeatedly acquiring the window value every window read cycle until the window value is less than the counter variable “i”; and
swapping an element corresponding to the window value for an element corresponding to the counter variable in the arrangement sequence.

7. The method as claimed in claim 1, wherein the acquiring of the window value comprises subtracting a counter variable “i” from a decimal value when the decimal value corresponding to “p” least significant bits (LSBs) included in the window within the PN sequence is larger than the counter variable “i,” which is set to “M−1” based on the size “M” of the hopping sequence upon the initialization of the shift register and is then decreased by one whenever the swapping is performed, in which “p” is the lowest integer satisfying i<2^{p}.

8. The method as claimed in claim 7, wherein the swapping comprises:
repeatedly acquiring the window value by a predetermined number of times every window read cycle; and
swapping an element corresponding to the window value for an element corresponding to the counter variable in the arrangement sequence.

9. An apparatus for generating a hopping sequence in a communication system, the apparatus comprising:
a pseudo-noise (PN) sequence generator including a shift register for generating a PN sequence; and
a controller for initializing an arrangement sequence having a length equal to that of the hopping sequence, for initializing the shift register to a seed value input for generating the hopping sequence, for acquiring a window value, which is a result obtained by applying a window to the PN sequence being an output of the shift register, every predetermined window read cycle, for swapping an element corresponding to the window value for another element in the arrangement sequence, for repeating the acquiring and swapping operation until all elements in the arrangement sequence have been swapped for each other, and for outputting the arrangement sequence as the hopping sequence after a complete of the repeating.

10. The apparatus as claimed in claim 9, wherein, the controller determines a size of the window according to a size of the hopping sequence, and determines a position to which the window is to be applied in the PN sequence.

11. The apparatus as claimed in claim 10, wherein the size of the window is “N” bits, in which “N” is determined to be the lowest integer satisfying M≦2ⁿ according to the size “M” of the hopping sequence.

12. The apparatus as claimed in claim 9, wherein the arrangement sequence is initialized to A[0]=0, A[1]=1, . . . , A[M−1]=M−1, in which A[x] represents each element in the arrangement sequence, and “M” represents the size of the hopping sequence.

13. The apparatus as claimed in claim 9, wherein the window value is determined to be a decimal value corresponding to “p” least significant bits (LSBs) included in the window within the PN sequence, in which “p” is the lowest integer satisfying i<2^{p} according to a counter variable “i,” which is set to “M−1” based on the size “M” of the hopping sequence upon the initialization of the shift register and is then decreased by one whenever the swapping operation is performed.

14. The apparatus as claimed in claim 13, wherein the controller repeatedly acquires the window value every window read cycle until the window value is less than the counter variable “i,” and swaps an element corresponding to the window value for an element corresponding to the counter variable in the arrangement sequence.

15. The apparatus as claimed in claim 9, wherein the window value is determined to be a value obtained by subtracting a counter variable “i” from a decimal value when the decimal value corresponding to “p” least significant bits (LSBs) included in the window within the PN sequence is larger than the counter variable “i,” which is set to “M−1” based on the size “M” of the hopping sequence upon initialization of the shift register and is then decreased by one whenever the swapping operation is performed, in which “p” is the lowest integer satisfying i<2^{p}.

16. The apparatus as claimed in claim 15, wherein the controller repeatedly acquires the window value by a predetermined number of times every window read cycle, and swaps an element corresponding to the window value for an element corresponding to the counter variable in the arrangement sequence.

17. A method for generating a hopping sequence in a communication system, the method comprising:
initializing a flag arrangement, having a length equal to the hopping sequence, to zero;
initializing a shift register, which is used to generate a pseudo-noise (PN) sequence, to a seed value input for generating the hopping sequence;
acquiring a window value, which is a result obtained by applying a window to the PN sequence being an output of the shift register, every predetermined window read cycle;
when a first element corresponding to the window value in the flag arrangement is zero, changing a first element to one and updating an element of an arrangement sequence, which has a size equal to the hopping sequence, to the window value;
repeating the acquiring, changing, and updating until all elements in the arrangement sequence have been updated; and
outputting the arrangement sequence as the hopping sequence after a complete of the repeating.

18. The method as claimed in claim 17, further comprising:
determining a size of the window according to a size of the hopping sequence; and
determining a position to which the window is to be applied in the PN sequence.

19. The method as claimed in claim 18, wherein the size of the window is “N” bits, in which “N” is determined to be the lowest integer satisfying M≦2ⁿ according to the size “M” of the hopping sequence.

20. The method as claimed in claim 19, wherein the updating comprises, until a counter variable “i,” which is set to zero upon the initialization of the shift register and is then increased by one whenever the updating step is performed, reaches a size “M” of the hopping sequence, updating an element corresponding to the counter variable among elements in the arrangement sequence to the window value.

21. An apparatus for generating a hopping sequence in a communication system, the apparatus comprising:
a pseudo-noise (PN) sequence generator including a shift register for generating a PN sequence; and
a controller for initializing a flag arrangement, having a length equal to that of the hopping sequence, to zero, for initializing the shift register to a seed value input for generating the hopping sequence, for acquiring a window value, which is a result obtained by applying a window to the PN sequence being an output of the shift register, every predetermined window read cycle, for changing a first element to one and updating an element in an arrangement sequence having a size equal to the hopping sequence to the window value when a first element corresponding to the window value in the flag arrangement is zero, for repeating the acquiring, changing, and updating step until all elements in the arrangement sequence have been updated, and for outputting the arrangement sequence as the hopping sequence after a complete of the repeating.

22. The apparatus as claimed in claim 21, wherein the controller determines a size of the window according to a size of the hopping sequence, and determines a position to which the window is to be applied in the PN sequence.

23. The apparatus as claimed in claim 22, wherein the size of the window is “N” bits, in which “N” is determined to be the lowest integer satisfying M≦2ⁿ according to the size “M” of the hopping sequence.

24. The apparatus as claimed in claim 23, wherein the controller updates an element corresponding to a counter variable among elements in the arrangement sequence, to the window value until the counter variable “i,” which is set to zero upon the initialization of the shift register and is then increased by one whenever the updating step is performed, reaches a size “M” of the hopping sequence.
